(19) United States
(12) Patent Application Publication
(10) Pub. No.: US 2026/0058360 A1
(43) Pub. Date: Feb. 26, 2026

(54) USER EQUIPMENT CALIBRATION OF MILLIMETER WAVE DEVICES FOR MECHANICAL ALIGNMENTS

(71) Applicant: QUALCOMM Incorporated, San Diego, CA (US)

(72) Inventors: Vasanthan RAGHAVAN, West Windsor Township, NJ (US); Tao LUO, San Diego, CA (US)

(21) Appl. No.: 18/812,939

(22) Filed: Aug. 22, 2024

(51) Int. Cl. H01Q 3/08; H04B 17/12

(52) U.S. Cl. CPC H01Q 3/08; H04B 17/12

(57) ABSTRACT

Various aspects of the present disclosure generally relate to wireless communication. Some wireless communications may include a user equipment (UE) (for example, a UE including multiple antenna panels each including an antenna array supported by mechanical components) may perform mechanical and/or physical adjustments to adjust mechanical alignments of one or more antenna panels of the UE. Some aspects more specifically relate to coordinating mechanical and/or physical adjustments with a network node which may include receiving mechanical adjustment information that may trigger a mechanical adjustment of the antenna panel by the UE. Coordinating the mechanical and/or physical adjustments with the network node may include transmitting the mechanical adjustment information indicating that the UE is to perform the mechanical adjustment. The mechanical adjustment information may include a start time for performing the mechanical adjustment and/or a duration for performing the mechanical adjustment.

### FIELD OF THE DISCLOSURE

Aspects of the present disclosure generally relate to wireless communication and specifically relate to techniques, apparatuses, and methods associated with user equipment (UE) calibration of millimeter wave (mmW) devices for mechanical alignments (for example, misalignments).

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmW) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies, such as 6G may be introduced, to further advance mobile broadband evolution.

Some wireless communications systems may include user equipment (UE), such as a customer premises equipment (CPE). Some CPEs include large antenna arrays (for example, 8×8 element antenna arrays, 16×8 element antenna arrays, and/or 16×16 element antenna arrays) which may cost more than smaller arrays. For example, large antenna arrays may cost more because they may be implemented with multiple radio frequency integrated circuit (RFIC) chips for RF support which may incur additional cost. As demand for lower-cost implementations for CPEs increases, CPEs may be implemented with smaller antenna arrays (for example, along with one or more reflectors (for example, focused and/or Cassegrain reflectors) for steering energy along one or more boresight direction(s) of the smaller antenna arrays. However, smaller antenna arrays may be more susceptible to mechanical displacement, such as mechanical misalignments, communicational misalignments, and/or mismatches in equipment and/or communication beams, than larger antenna arrays. Mechanical displacements and/or misalignments in communications between the CPE and a network node may decrease a signal quality between the CPE and the network node.

### SUMMARY

Some aspects described herein relate to a user equipment (UE) for wireless communication. The user equipment may include a processing system that includes one or more processors and one or more memories coupled with the one or more processors. The processing system may be configured to cause the user equipment to communicate, in accordance with an alignment of one or more antenna panels of the UE, information for a mechanical adjustment of at least one antenna panel of a set of antenna panels of the UE relative to another antenna panel of the set of antenna panels of the UE, the information for the mechanical adjustment indicating a start time and a duration associated with performing the mechanical adjustment. The processing system may be configured to cause the user equipment to perform, in accordance with the information, the mechanical adjustment of the at least one antenna panel.

Some aspects described herein relate to a network node for wireless communication. The network node may include a processing system that includes one or more processors and one or more memories coupled with the one or more processors. The processing system may be configured to cause the network node to communicate, in accordance with an alignment of one or more antenna panels of a UE, information for a mechanical adjustment of at least one antenna panel of a set of antenna panels of the UE relative to another antenna panel of the set of antenna panels of the UE, the information for the mechanical adjustment indicating a start time and a duration associated with performance of the mechanical adjustment. The processing system may be configured to cause the network node to communicate using the at least one antenna panel in accordance with the communicating the information for the mechanical adjustment.

Some aspects described herein relate to a method of wireless communication by a UE. The method may include communicating, in accordance with an alignment of one or more antenna panels of the UE, information for a mechanical adjustment of at least one antenna panel of a set of antenna panels of the UE relative to another antenna panel of the set of antenna panels of the UE, the information for the mechanical adjustment indicating a start time and a duration associated with performing the mechanical adjustment. The method may include performing, in accordance with the information, the mechanical adjustment of the at least one antenna panel. The method may include communicating using the at least one antenna panel in accordance with performing the mechanical adjustment.

Some aspects described herein relate to a method of wireless communication by a network node. The method may include communicating, in accordance with an alignment of one or more antenna panels of a UE, information for a mechanical adjustment of at least one antenna panel of a set of antenna panels of the UE relative to another antenna panel of the set of antenna panels of the UE, the information for the mechanical adjustment indicating a start time and a duration associated with performance of the mechanical adjustment. The method may include communicating using the at least one antenna panel in accordance with the communicating the information for the mechanical adjustment.

Some aspects described herein relate to a non-transitory computer-readable medium that stores a set of instructions for wireless communication by a UE. The set of instructions, when executed by one or more processors of the UE, may cause the UE to communicate, in accordance with an alignment of one or more antenna panels of the UE, information for a mechanical adjustment of at least one antenna panel of a set of antenna panels of the UE relative to another antenna panel of the set of antenna panels of the UE, the information for the mechanical adjustment indicating a start time and a duration associated with performing the mechanical adjustment. The set of instructions, when executed by one or more processors of the UE, may cause the UE to perform, in accordance with the information, the mechanical adjustment of the at least one antenna panel.

Some aspects described herein relate to a non-transitory computer-readable medium that stores a set of instructions for wireless communication by a network node. The set of instructions, when executed by one or more processors of the network node, may cause the network node to communicate, in accordance with an alignment of one or more antenna panels of a UE, information for a mechanical adjustment of at least one antenna panel of a set of antenna panels of the UE relative to another antenna panel of the set of antenna panels of the UE, the information for the mechanical adjustment indicating a start time and a duration associated with performance of the mechanical adjustment.

Some aspects described herein relate to an apparatus for wireless communication. The apparatus may include means for communicating, in accordance with an alignment of one or more antenna panels of the UE, information for a mechanical adjustment of at least one antenna panel of a set of antenna panels of the UE relative to another antenna panel of the set of antenna panels of the UE, the information for the mechanical adjustment indicating a start time and a duration associated with performing the mechanical adjustment. The apparatus may include means for performing, in accordance with the information, the mechanical adjustment of the at least one antenna panel. The apparatus may include means for communicating using the at least one antenna panel in accordance with performing the mechanical adjustment.

Some aspects described herein relate to an apparatus for wireless communication. The apparatus may include means for communicating, in accordance with an alignment of one or more antenna panels of a UE, information for a mechanical adjustment of at least one antenna panel of a set of antenna panels of the UE relative to another antenna panel of the set of antenna panels of the UE, the information for the mechanical adjustment indicating a start time and a duration associated with performance of the mechanical adjustment. The apparatus may include means for communicating using the at least one antenna panel in accordance with the communicating the information for the mechanical adjustment.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example user equipment (UE) in a wireless network in accordance with the present disclosure.

FIG. 3 is a diagram illustrating an example disaggregated base station architecture in accordance with the present disclosure.

FIG. 4 is a diagram illustrating an example of a millimeter wave (mmW) device in accordance with the present disclosure.

FIG. 5 is a diagram of an example associated with calibration of mmW devices in accordance with the present disclosure.

FIG. 6A is a diagram illustrating an example of a mmW device with adjustable antenna panels in accordance with the present disclosure.

FIG. 6B is a diagram illustrating an example of a mmW device with adjustable antenna panels in communication with multiple network nodes in accordance with the present disclosure.

FIG. 7 is a flowchart illustrating an example process performed, for example, at a UE or an apparatus of a UE that supports mmW calibration in accordance with the present disclosure.

FIG. 8 is a flowchart illustrating an example process performed, for example, at a network node or an apparatus of a network node that supports calibration of mmW device in accordance with the present disclosure.

FIG. 9 is a diagram of an example apparatus for wireless communication that supports calibration of mmW devices in accordance with the present disclosure.

FIG. 10 is a diagram of an example apparatus for wireless communication that supports calibration of mmW devices in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Some wireless communications systems may include user equipment (UE), such as a customer premises equipment (CPE). A CPE may include telecommunications and/or information technology equipment that operates at a customer or user's physical location rather than at a location of the service provider. In some examples, a CPE may include a millimeter wave (mmW) device for operations in mmW frequency bands. A CPE may include a set of at least one antenna array or antenna panel that includes an antenna array. Some CPEs include large antenna arrays (for example, 8×8 element antenna arrays, 16×8 element antenna arrays, 16×16 element antenna arrays and/or larger antenna arrays) which may cost more than smaller antenna arrays. As demand for lower-cost implementations for CPEs increases, CPEs may be implemented with multiple smaller antenna arrays rather than a single larger antenna array. Some CPEs may include a reflector and/or a mechanical rotator corresponding to each antenna panel which may support communication parameters, such as radiated power and array gain without the use of large antenna arrays. Smaller antenna arrays supported by a reflector and/or a mechanical rotator may also support lower power consumption, lower thermal overhead associated with CPE/antenna array operations, and overall lower cost of the materials used to manufacture the CPE.

However, a reflector, mechanical rotator, and antenna panel combination may be more susceptible to mechanical displacements than a larger antenna array due to more moving components. For example, after time, a default position of the antenna panel, reflector, and/or rotator may drift out of alignment with each other and/or with a network node in communication with the antenna panel and may cause a degradation in communication parameters. For example, mechanical displacements and/or misalignments may decrease a signal quality between the CPE and the network node.

Various aspects relate generally to techniques in which a CPE (for example, a low-cost CPE including multiple antenna panels each including an antenna array supported by mechanical components) may perform mechanical and/or physical adjustments to benefit uplink, downlink, and/or full duplex communications and/or to account for mechanical misalignments caused by use of the device over time. Some aspects more specifically relate to coordinating mechanical and/or physical adjustments with a network node which may include receiving an indication (for example, including mechanical adjustment information) that may trigger performance of a mechanical adjustment of the antenna panel and/or an element corresponding to the antenna panel. In some aspects, coordinating the mechanical and/or physical adjustments with the network node may include transmitting an indication (for example, including the mechanical adjustment information) that the CPE is to perform a mechanical adjustment. In some aspects, the mechanical adjustment information may include a start time for performing the mechanical adjustment and a duration for performing the mechanical adjustment (for example, including a duration to perform the mechanical adjustment and/or a duration for transitioning from performing the mechanical adjustment to communicating).

In some aspects, the duration for performing the mechanical adjustment may have a large dynamic range (for example, may vary greatly from instance to instance and/or from device to device). As a result, the duration for performing the mechanical adjustment may be quantized (for example, subdivided to a largest whole integer measurement) to a nearest whole integer multiple of a time-period. For example, time-periods having a quantization (for example, a whole integer sub-division) of 1 second, a time-period of 13.25 seconds used to perform the mechanical adjustment may be quantized as 13 seconds or 14 seconds. In some aspects, the CPE and the network node may refrain from communicating with one another for the duration of performing the mechanical adjustment initiated from the indicated start time. For example, the CPE may not be enabled to perform the mechanical adjustment and communications simultaneously. In some aspects, the mechanical adjustment information may be based on or otherwise associated with one or more performance indicators. For example, the CPE and/or the network node may identify that a performance indicator associated with communications between the CPE and the network node has decreased enough that a mechanical adjustment is warranted. In such aspects, the mechanical adjustment may include one or more adjustments to address the degraded performance indicator.

Particular aspects of the subject matter described in this disclosure can be implemented to realize one or more of the following potential advantages. In some examples, the described techniques can be used to maintain performance of a CPE over time. For example, by communicating the information for a mechanical adjustment, the described techniques may be used to coordinate the mechanical adjustment such that a network node and the CPE have the same mechanical adjustment information and may adjust and/or perform one or more operations accordingly to decrease errors and increase channel quality. As another example, by refraining from communicating while performing the mechanical adjustment, the described techniques may be used to avoid communication errors and/or missed communications by the network node that may otherwise be transmitted during performance of the mechanical adjustment. By performing a mechanical adjustment that includes one or more adjustments to address a degraded performance indicator, the described techniques may be used to increase the overall quality of communications between the CPE and the network node and may be used to prioritize some performance indicators over others that may be more important in some deployment scenarios than other deployment scenarios.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), mmW technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases, such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

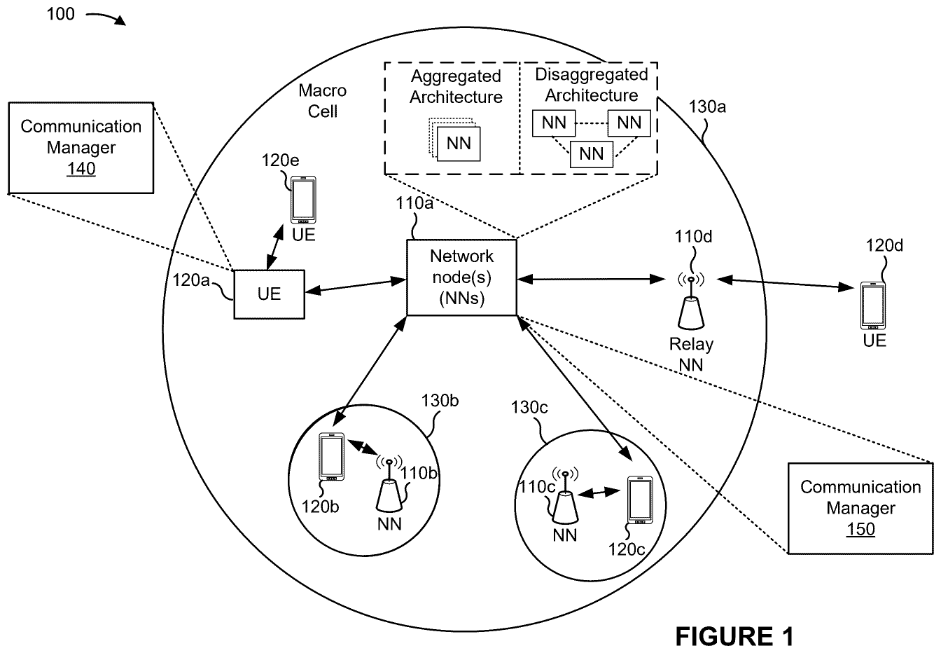

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “mmW” band in some documents and articles, despite being different than the extremely high frequency (EHF) band (30 GHz through 300 GHz), which is identified by the International Telecommunications Union (ITU) as a “mmW” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “mmW,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media, such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may communicate, in accordance with an alignment of one or more antenna panels of the UE, information for a mechanical adjustment of at least one antenna panel of a set of antenna panels of the UE relative to another antenna panel of the set of antenna panels of the UE, the information for the mechanical adjustment indicating a start time and a duration associated with performing the mechanical adjustment; perform, in accordance with the information, the mechanical adjustment of the at least one antenna panel; and communicate using the at least one antenna panel in accordance with performing the mechanical adjustment. Additionally, or alternatively, the communication manager 140 may perform one or more other operations described herein.

In some aspects, the network node 110 may include a communication manager 150. As described in more detail elsewhere herein, the communication manager 150 may communicate, in accordance with an alignment of one or more antenna panels of a UE, information for a mechanical adjustment of at least one antenna panel of a set of antenna panels of the UE relative to another antenna panel of the set of antenna panels of the UE, the information for the mechanical adjustment indicating a start time and a duration associated with performance of the mechanical adjustment; and communicate using the at least one antenna panel in accordance with the communicating the information for the mechanical adjustment. Additionally, or alternatively, the communication manager 150 may perform one or more other operations described herein.

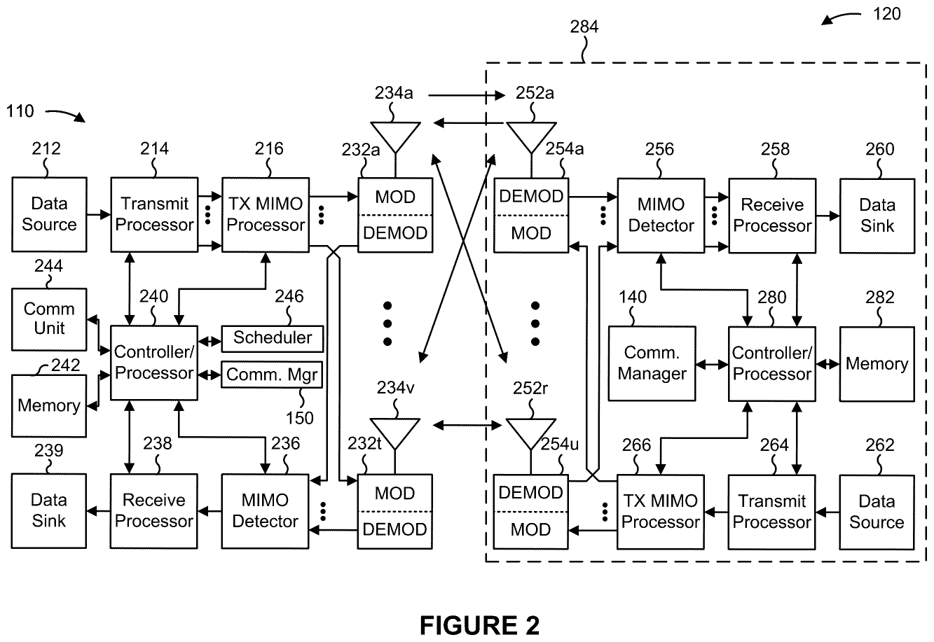

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects, in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more modulation and coding schemes (MCSs) for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC-CE communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects, in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a received signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels, such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different quantities of antenna elements. For example, a UE 120 may include a single antenna element, two antenna elements, four antenna elements, eight antenna elements, or a different quantity of antenna elements. As another example, a network node 110 may include eight antenna elements, 24 antenna elements, 64 antenna elements, 128 antenna elements, or a different quantity of antenna elements. Generally, a larger quantity of antenna elements may provide increased control over parameters for beam generation relative to a smaller quantity of antenna elements, whereas a smaller quantity of antenna elements may be less complex to implement and may use less power than a larger quantity of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

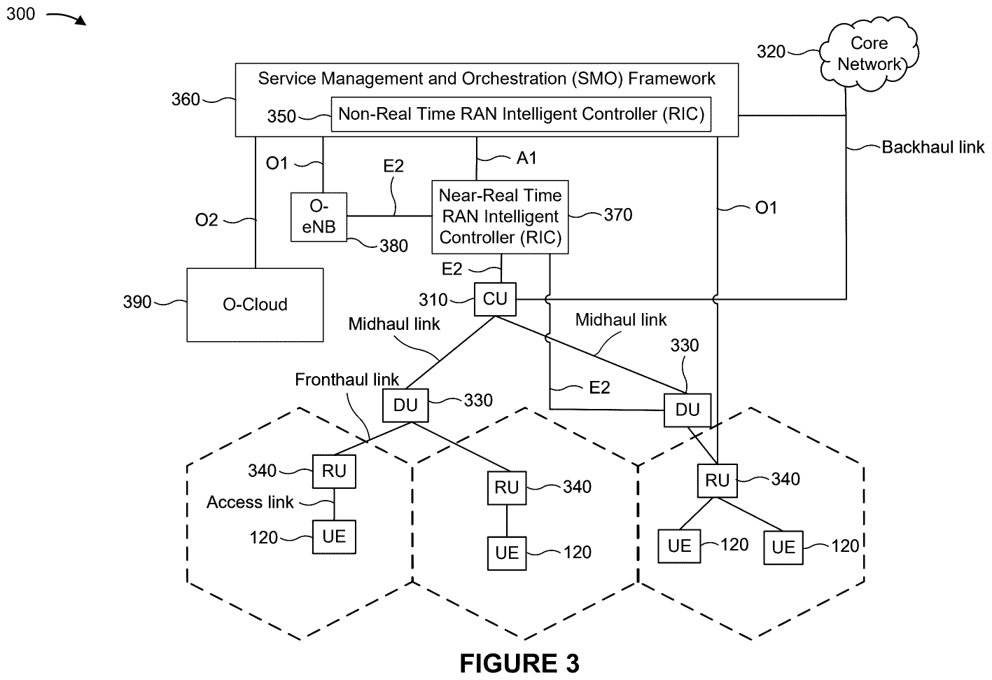

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

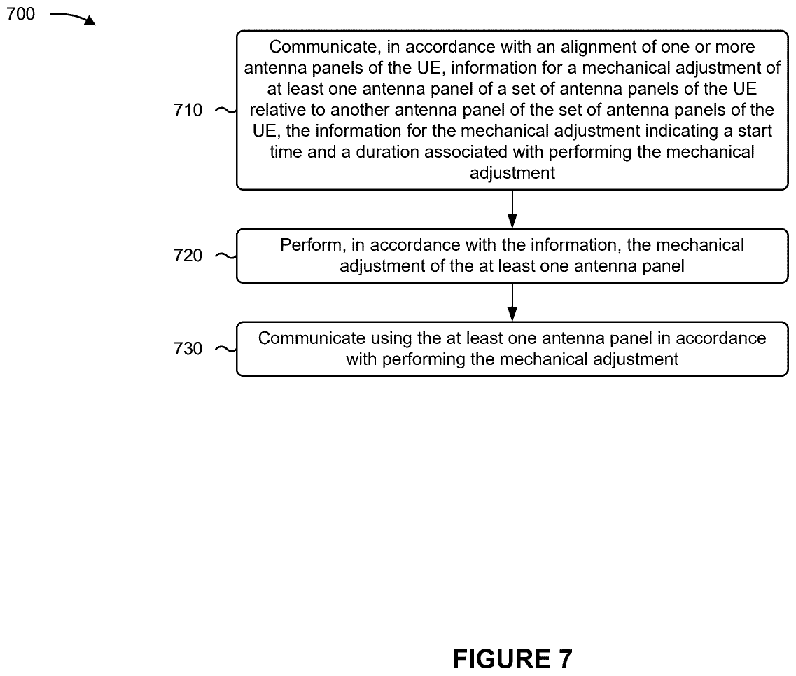

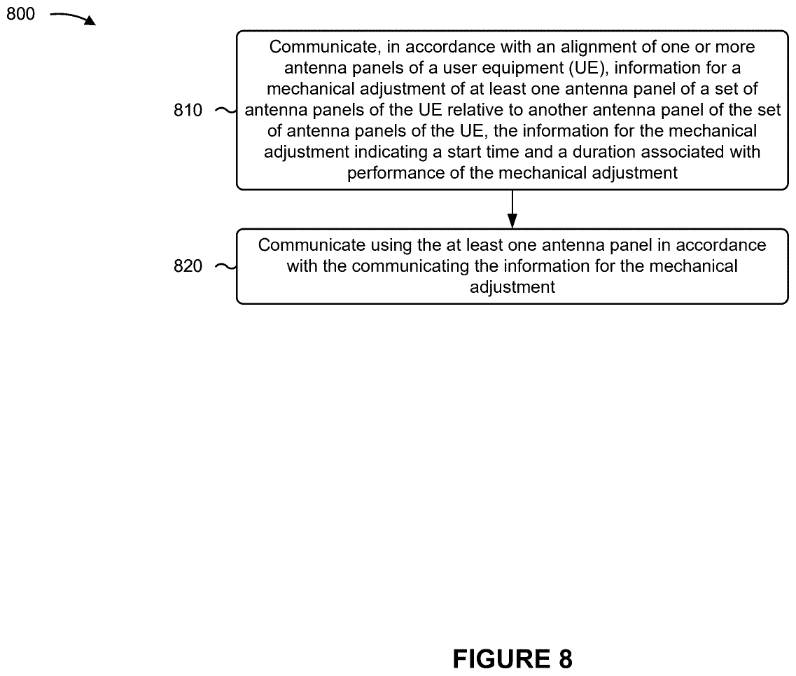

The network node 110, the controller/processor 240 of the network node 110, the UE 120, the controller/processor 280 of the UE 120, the CU 310, the DU 330, the RU 340, or any other component(s) of FIGS. 1, 2, or 3 may implement one or more techniques or perform one or more operations associated with UE calibration of millimeter wave devices for mechanical alignments, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 700 of FIG. 7, process 800 of FIG. 8, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 700 of FIG. 7, process 800 of FIG. 8, or other processes as described herein. In some examples, executing instructions may include running the instructions, converting the instructions, compiling the instructions, and/or interpreting the instructions, among other examples.

In some aspects, the UE includes means for communicating, in accordance with an alignment of one or more antenna panels of the UE, information for a mechanical adjustment of at least one antenna panel of a set of antenna panels of the UE relative to another antenna panel of the set of antenna panels of the UE, the information for the mechanical adjustment indicating a start time and a duration associated with performing the mechanical adjustment; means for performing, in accordance with the information, the mechanical adjustment of the at least one antenna panel; and/or means for communicating using the at least one antenna panel in accordance with performing the mechanical adjustment. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for communicating, in accordance with an alignment of one or more antenna panels of a UE, information for a mechanical adjustment of at least one antenna panel of a set of antenna panels of the UE relative to another antenna panel of the set of antenna panels of the UE, the information for the mechanical adjustment indicating a start time and a duration associated with performance of the mechanical adjustment; and/or means for communicating using the at least one antenna panel in accordance with the communicating the information for the mechanical adjustment. The means for the network node to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

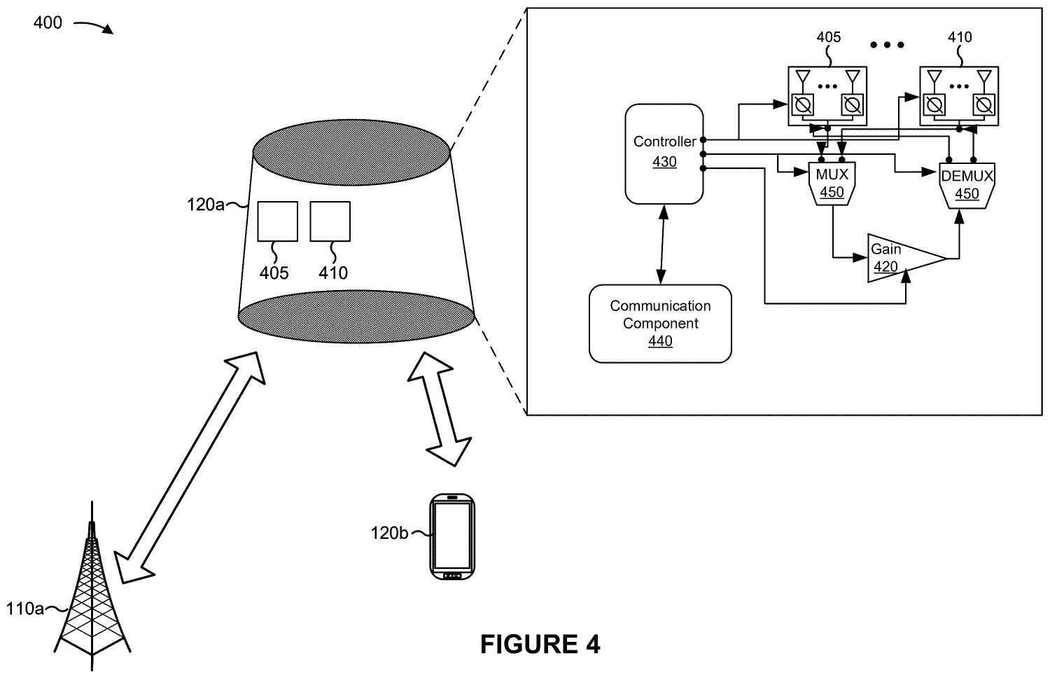

FIG. 4 is a diagram illustrating an example 400 of a mmW device in accordance with the present disclosure. The example 400 includes a UE 120a that may be an example of a CPE, and a network node 110a and a UE 120b, both connected to the UE 120a via a wireless communication link. The UE 120a may include telecommunications and/or information technology equipment that operates at a customer or user's physical location and may include a mmW device for communications in mmW frequency bands. The UE 120a may include a set of one or more antenna arrays or antenna panels including an antenna array. For example, the UE 120a in the example 400 include a first antenna panel 405 and a second antenna panel 410. The UE 120a may include one or more antenna panels in addition to antenna panels 405 and 410, a gain component 420, a controller 430, a communication component 440, and a multiplexer (MUX) and/or demultiplexer (DEMUX) (MUX/DEMUX) 450.

The antenna panels 405 and/or 410 may include multiple antenna elements capable of being configured for beamforming. In some aspects, the antenna panel 405 and/or the antenna panel 410 may be a fixed receive antenna array capable of only receiving communications while not transmitting communications. In some aspects, the antenna panel 405 and/or the antenna panel 410 may be a fixed transmit antenna array capable of only transmitting communications while not receiving communications. In some aspects, the antenna panel 405 and/or the antenna panel 410 may be capable of being configured to act as a receive antenna array and/or a transmit antenna array, and/or may be configured for full duplex communications. The antenna panel 405 and/or the antenna panel 410 may be capable of communicating using mmW frequency bands.

Gain component 420 includes a component capable of amplifying an input signal and outputting an amplified signal. For example, gain component 420 may include a power amplifier and/or a variable gain component. In some aspects, gain component 420 may have variable gain control. The gain component 420 may connect to an receive antenna array and a transmit antenna array such that a millimeter wave signal, received via the receive antenna array, can be amplified by the gain component 420 and output to the transmit antenna array for transmission. In some aspects, the level of amplification of the gain component 420 may be controlled by the controller 430.

Controller 430 includes a component capable of controlling one or more other components of the UE 120a. For example, the controller 430 may include a controller, a microcontroller, and/or a processor. In some aspects, the controller 430 may control the gain component 420 by controlling a level of amplification or gain applied by the gain component 420 to an input signal. Additionally, or alternatively, the controller 430 may control the antenna panel 405 and/or the antenna panel 410 by controlling a beamforming configuration for the antenna panel 405 and/or the antenna panel 410 (for example, one or more phase values, one or more phase offsets, one or more power parameters, one or more beamforming parameters, a transmit beamforming configuration, and/or an receive beamforming configuration), by controlling whether the antenna panel 405 and/or the antenna panel 410 acts as an receive antenna array and/or a transmit antenna array (for example, by configuring interaction and/or connections between the antenna panel 405 and/or the antenna panel 410 and a MUX/DEMUX 450) Additionally, or alternatively, the controller 430 may power on or power off one or more components of UE 120a. In some aspects, the controller 430 may control a timing of one or more of the above configurations.

Communication component 440 may include a component capable of wirelessly communicating with a network node 110 using a wireless technology other than millimeter wave (for example, via a control interface). For example, the communication component 440 may communicate with the network node 110 using a personal area network (PAN) technology (for example, Bluetooth or Bluetooth Low Energy (BLE)), a 4G or LTE radio access technology, a narrowband Internet of Things (NB-IoT) technology, a sub-6 GHz technology, a visible light communication technology, and/or the like. In some aspects, the communication component 440 may use a lower frequency communication technology, and the antenna panel 405 and/or the antenna panel 410 may use a higher frequency communication technology (for example, millimeter wave). In some aspects, the antenna panel 405 and/or the antenna panel 410 may be used to transfer data between the UE 120a and the network node 110, and the communication component 440 may be used to transfer control information between the UE 120a and the network node 110 (for example, a report, a configuration, and/or instructions to power on or power off one or more components).

MUX/DEMUX 450 may be used to multiplex and/or demultiplex communications received from and/or transmitted to an antenna array 410. For example, MUX/DEMUX 450 may be used to switch an receive antenna array to a transmit antenna array.

In some aspects, one or more of the antenna panel 405 and/or the antenna panel 410, gain component 420, controller 430, communication component 440, and/or MUX/DEMUX 450 may perform one or more techniques associated with UE calibration of mmW devices for mechanical alignments, as described in more detail elsewhere herein.

Because millimeter wave communications have a higher frequency and shorter wavelength than other types of radio waves used for communications (for example, sub-6 GHz communications), millimeter wave communications may have shorter propagation distances and may be more easily blocked by obstructions than other types of radio waves. For example, a wireless communication that uses sub-6 GHz radio waves may be capable of penetrating a wall of a building or a structure to provide coverage to an area on an opposite side of the wall from a network node 110 that communicates using the sub-6 GHz radio waves. However, a millimeter wave may not be capable of penetrating the same wall (for example, depending on a thickness of the wall and/or a material from which the wall is constructed). Some techniques and apparatuses described herein use a mmW device, such as UE 120a to increase the coverage area of a network node 110 and/or to extend coverage to other UEs.

The UE 120a may perform directional communication by using antenna panels 405 and/or 410 and beamforming to communicate with a network node 110 via. For example, in example 400, UE 120a can communicate with the network node 110 via a first beam pair and can communicate with UE 120b via a second beam pair. A beam pair may refer to a transmit beam used by a first device for transmission and a receive beam used by a second device for reception of information transmitted by the first device via the Tx beam.

A network node may use a beam sweeping procedure to transmit communications via multiple beams over time (for example, using time division multiplexing (TDM)). The UE 120a may receive a communication via an Rx beam of the UE 120a. The UE 120a may relay each received communication via multiple Tx beams of the UE 120a. As used herein, relaying a communication may refer to transmitting the received communication (for example, after amplifying the received communication) without decoding the received communication and/or without modifying information carried in the received communication. Alternatively, relaying a received communication may refer to transmitting the received communication after decoding the received communication and/or modifying information carried in the received communication. In some aspects, a received communication may be relayed using a different time resource, a different frequency resource, and/or a different spatial resource (for example, a different beam) to transmit the communication as compared to a time resource, a frequency resource, and/or a spatial resource in which the communication was received. The UE 120b may receive a relayed communication. In some aspects, the UE 120b may generate a communication to be transmitted to the network node 110. The UE 120b may then transmit the communication to the UE 120a for relaying to the network node 110.

The antenna panel 405 and/or the antenna panel 410 may be co-located and/or similarly located for communications with a single network node. The 120a may include a mechanical displacement apparatus (for example, at least one motor) that may rotate, reflect, or displace the antenna panel 405 and/or the antenna panel 410 and/or any corresponding components, such as the reflector. The mechanical displacement apparatus may separate and/or displace the antenna panel 405 and/or the antenna panel 410. In such examples, the displacement may be linear, angular, and or rotational.

Some CPEs, such as UE 120a may include large antenna arrays (for example, 8×8 element antenna arrays, 16×8 element antenna arrays, 16×16 element antenna arrays) which may cost more than smaller arrays. As demand for lower-cost implementations for CPEs increases, CPEs may implemented with smaller antenna arrays. Some CPEs, such as the UE 120a may include a reflector and/or a mechanical rotator corresponding to each antenna panel which may support communication parameters, such as radiated power and array gain without the use of large antenna arrays. Smaller antenna arrays supported by a reflector and/or a mechanical rotator may also support power consumption, thermal overhead, and overall cost of the materials to manufacture the UE 120a.

However, the reflector, mechanical rotator, antenna panel combination may be more susceptible to mechanical displacements than larger antenna arrays due to more moving components. For example, after time, a default position of the antenna panel, reflector, rotator may drift out of alignment with each other and/or with the network node 110a in communication with the antenna panel 405 and/or the antenna panel 410 and may cause a degradation in communication parameters. For example, mechanical displacements and/or misalignments may decrease signal quality between the UE 120a and the network node.

Other examples of the UE 120a may differ from what is described in FIG. 4. For example, the UE 120a may include additional components, fewer components, different components, or differently arranged components than those shown in FIG. 4. Furthermore, two or more components shown in FIG. 4 may be implemented within a single component, or a single component shown in FIG. 4 may be implemented as multiple components. Additionally, or alternatively, a set of components (for example, one or more components) of the UE 120a may perform one or more functions described as being performed by another set of components of UE 120a.

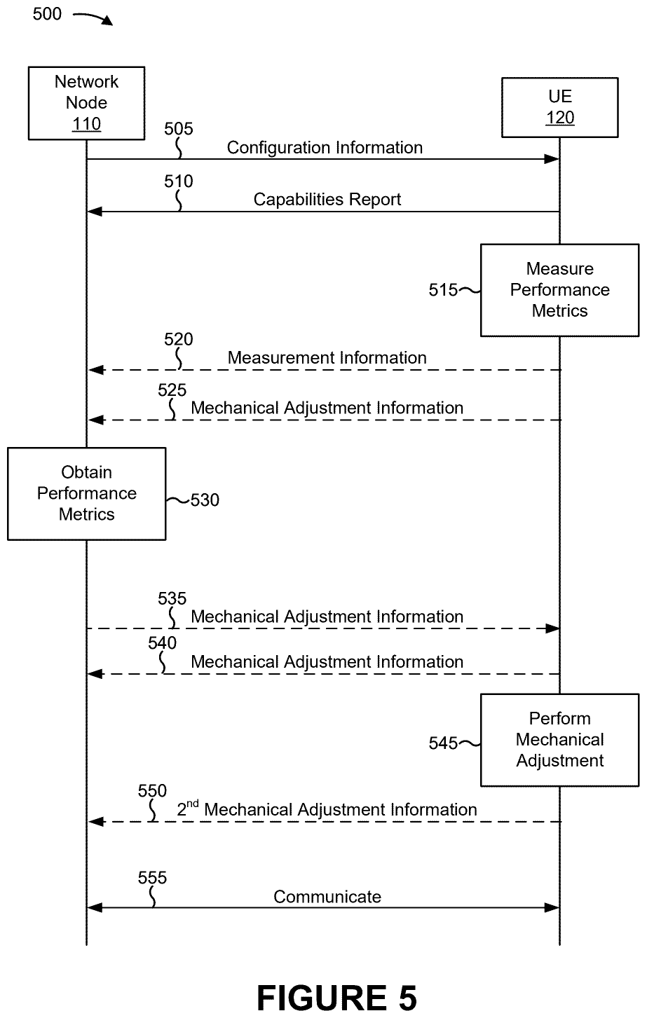

FIG. 5 is a diagram of an example 500 associated with calibration of mmW devices in accordance with the present disclosure. As shown in FIG. 5, a network node (for example, network node 110, a CU, a DU, and/or an RU) may communicate with a UE 120 (for example, UE 120). In some aspects, the network node and the UE 120 may be part of a wireless communication network (for example, wireless communication network 100). The UE 120 and the network node 110 may have established a wireless connection prior to operations shown in FIG. 5.

In a first operation 505, the network node 110 may transmit, and the UE 120 may receive, configuration information. In some aspects, the UE 120 may receive the configuration information via one or more of system information (for example, a master information block (MIB) and/or a system information block (SIB), among other examples), RRC signaling, one or more MAC control elements (CEs), and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (for example, an indication described herein) may include a dynamic indication, such as one or more MAC CEs and/or one or more DCI messages, among other examples.

In some aspects, the configuration information may indicate that the UE is to enable antenna panel calibration and/or measure one or more performance metrics that may trigger antenna panel calibration.

The UE 120 may configure itself based at least in part on the configuration information. In some aspects, the UE 120 may be configured to perform one or more operations described herein based at least in part on the configuration information.

In a second operation 510, the UE 120 may transmit, and the network node 110 may receive, a capabilities report. The capabilities report may indicate whether the UE 120 supports a feature and/or one or more parameters related to the feature. For example, the capability information may indicate a capability and/or parameter for performing a mechanical adjustment of one or more antenna panels of the UE 120. As another example, the capabilities report may indicate a capability and/or parameter for measuring one or more performance metrics associated with communications between the UE 120 and the network node 110. One or more operations described herein may be based on capability information of the capabilities report. For example, the UE 120 may perform a communication in accordance with the capability information, or may receive configuration information that is in accordance with the capability information.

In some aspects, the capabilities report may indicate a mechanical adjustment capability (for example, whether the UE 120 may physically move one or more antenna panels), a rotational displacement capability (for example, whether the UE 120 may physically rotate one or more antenna panels), a translational displacement capability (for example, whether the UE 120 may linearly move one or more antenna panels), an angular displacement capability (for example, whether the UE 120 may physically move one or more antenna panels on a circular path), a duration for performing the mechanical adjustment (for example, a duration for the UE 120 to complete the mechanical adjustment), a duration for transitioning from performing the mechanical adjustment to communicating in accordance with performing the mechanical adjustment (for example, a duration between the UE 120 completing the mechanical adjustment and resuming communications).

In some aspects, the configuration information and/or the capabilities report may include information transmitted via multiple communications. Additionally, or alternatively, the network node 110 may transmit the configuration information, or a communication including at least a portion of the configuration information, before and/or after the UE 120 transmits the capabilities report. For example, the network node 110 may transmit a first portion of the configuration information before the capabilities report, the UE 120 may transmit at least a portion of the capabilities report, and the network node 110 may transmit a second portion of the configuration information after receiving the capabilities report.

In a third operation 515, the UE 120 may measure one or more performance metrics. For example, the UE 120 may measure one or more performance metrics associated with communications between the UE 120 and the network node 110. The one or more performance metrics may include an alignment metric, a throughput metric, a robustness metric, an outage probability, a bit error rate, a cross talk metric, and/or a signal leakage metric, associated with communications between the network node 110 and the UE 120. The alignment metric may be a metric associated with how the position of the one or more affects communications between the network node 110 and the UE 120. The throughput metric may be a metric associated with an amount of data and/or communications communicated between the network node 110 and the UE 120. The robustness metric may be a metric associated with maintaining reliable and consistent performance under various conditions. Such conditions may include interference, signal fading, noise, environmental changes, mobility, and other factors that might degrade the quality of the wireless communication channel between the network node 110 and the UE 120. The outage probability may include a probability that signal to noise ratio (SNR), signal to interference and noise ratio (SINR), or a received power level decreases below a value associated with an acceptable communication quality. The bit error rate may be a rate at which errors occur in communications between the network node 110 and the UE. The cross talk metric may be associated interference caused by communications via a first channel and/or frequency band affecting communications via a second channel and/or frequency band. The signal leakage metric may be associated with a loss of signal during communication. In some aspects, the measured performance metrics may be indicative of an alignment of the one or more panels of the UE 120.

In some examples, in a fourth operation 520, the UE 120 may transmit, and the network node 110 may receive measurement information.

In a fifth operation 525, the UE 120 may transmit, and the network node 110 may receive mechanical adjustment information. For example, the UE 120 may transmit, in accordance with the alignment of the one or more antenna panels of the UE 120, information for the mechanical adjustment of at least one antenna panel of a set of antenna panels of the UE 120 relative to another antenna panel of the set of antenna panels of the UE 120. In some aspects, the information for the mechanical adjustment may indicate a start time and a duration associated with performing the mechanical adjustment.

In some aspects, the information for the mechanical adjustment may indicate an angular distance (for example, a displacement along a circular path), a translational distance (for example, a displacement along a linear path), a rotational distance (for example, a degree of rotation), a key performance indicator (for example, one or more measured performance metrics), and/or other properties of the UE 120 (for example, a physical property, a wireless communication channel property, a quantity of antenna panels of the UE 120, among other examples).

In a sixth operation 530, the network node 110 may obtain performance metrics. For example, the network node 110 may obtain a measurement of one or more performance metrics associated with communications between the UE 120 and the network node 110. In such aspects, communicating the information for the mechanical adjustment may be associated with at least one of the one or more performance metrics satisfying a condition. In some examples, obtaining the performance metrics may be based on or otherwise associated with receiving the measurement information as part of the fourth operation. In some other aspects, obtaining the performance metrics may be based on or otherwise associated with the network node 110 performing one or more measurements and/or measuring the one or more performance metrics.

In a seventh operation 535, the network node 110 may transmit, and the UE 120 may receive mechanical adjustment information. For example, the network node 110 may transmit, and the UE 120 may receive the information for the mechanical adjustment. In some aspects, the mechanical adjustment may include a first mechanical displacement of the at least one antenna panel. In some aspects, the network node 110 may transmit, and the UE 120 may receive the information for the mechanical adjustment via a downlink control channel (for example, PDCCH), a downlink control message (for example, DCI), and/or other downlink signaling.

In an eighth operation 540, the UE 120 may transmit, and the network node 110 may receive mechanical adjustment information for a different mechanical adjustment. For example, the UE 120 may transmit, and the network node 110 may receive, information for a different mechanical adjustment including an indication of a second mechanical displacement different from the first mechanical displacement. In some aspects, the information for the different mechanical adjustment includes a duration associated with performing the different mechanical adjustment. In some aspects, the UE 120 may transmit, and the network node 110 may receive the information via at least one of an uplink control channel (for example, a PUCCH), a UCI message, or other uplink signaling.

In some aspects, communicating the information for the mechanical adjustment as part of the fifth operation 525, the seventh operation 535, and/or the eighth operation 540 is associated with at least one of the one or more performance metrics satisfying a condition. For example, communicating the information for the mechanical adjustment may be based on, or otherwise associated with identifying or otherwise determining that at least one of the performance metrics measured as part of the third operation satisfies a threshold. The threshold may be based on, or otherwise associated with a quality of communications between the network node 110 and the UE 120. For example, the network node 110 and/or the UE 120 may use a degradation in any of the performance metrics as a trigger for transmitting the mechanical adjustment information and/or performing the mechanical adjustment.

In some aspects, communicating the information for the mechanical adjustment as part of the fifth operation 525, the seventh operation 535, and/or the eighth operation 540 may include communicating information for a first mechanical adjustment of a first antenna panel of the set of antenna panels and communicating information for a second mechanical adjustment of a second antenna panel of the set of antenna panels. In some aspects, the first mechanical adjustment and the second mechanical adjustment are a same mechanical adjustment. In some aspects, the first mechanical adjustment and the second mechanical adjustment are different. In some aspects, communicating the information for the first mechanical adjustment includes receiving, from the network node 110, information for the first mechanical adjustment in accordance with a first one or more performance metrics associated with communications between the UE 120 and the network node 110 satisfying a first condition. In such aspects, communicating the information for the second mechanical adjustment includes receiving, from a second network node (for example, a second network node 110), information for the second mechanical adjustment in accordance with a second one or more performance metrics associated with communications between the UE 120 and the second network node satisfying at least one of the first condition or a second condition.

In some aspects, the information for the mechanical adjustment (for example, communicated as part of the fifth operation 525, the seventh operation 535, and/or the eighth operation 540) may include an indication of a physical property of the UE 120, an indication of an adjustment of the physical property of the UE 120, one or more key performance indicators for initiating an additional mechanical adjustment, and/or one or more key performance indicators that triggered the mechanical adjustment. For example, the network node 110 and the UE 120 may exchange signaling to adjust a linear separation between antenna panels of the UE 120, an angular separation between antenna panels of the UE 120 and/or other physical properties and/or performance indicators associated with communications at the UE 120.

In some aspects, the UE 120 may include comprises a first antenna panel, of the set of antenna panels, associated with communications via a first frequency range and a second antenna panel, of the set of antenna panels, associated with communications via a second frequency range. In such aspects, the information for the mechanical adjustment may be associated with cross-frequency leakage of the communications via the first frequency range and the communications via the second frequency range.

In a ninth operation 545, the UE 120 may perform the mechanical adjustment. For example, the UE 120 may perform, in accordance with the information for the mechanical adjustment, the mechanical adjustment of the at least one antenna panel. In some aspects, performing the mechanical adjustment may include performing the different mechanical adjustment of the at least one antenna panel. In such aspects, the different mechanical adjustment may include a second mechanical displacement different from the first mechanical displacement of the at least one antenna panel.

In some aspects, the mechanical adjustment may include a displacement of the at least one antenna panel with respect to an initial position of the at least one antenna panel. In some aspects, the mechanical adjustment may include a displacement of the at least one antenna panel with relative to the other antenna panel.

In some aspects, the UE 120 may refrain from communicating for the duration associated with performing the mechanical adjustment. For example, the UE 120 may refrain from transmitting and/or receiving communications while performing the mechanical adjustment.

In some aspects, the at least one antenna panel may be collocated with the other antenna panel of the UE 120 prior to the mechanical adjustment. In some aspects, a location of the at least one antenna panel may be adjustable, and the other antenna panel may have a fixed location.

In a tenth operation 550, the UE 120 may transmit, and the network node 110 may receive second mechanical adjustment information. For example, the UE 120 may transmit, and the network node 110 may receive an indication of the second mechanical displacement. In some aspects, communicating the indication of the second mechanical displacement is associated with or otherwise based on performing the different mechanical adjustment of the at least one antenna panel. For example, the UE 120 may transmit, and the network node 110 may receive an indication of the second mechanical displacement and/or information for the different mechanical adjustment including the indication of the second mechanical displacement different from the first mechanical displacement after performing the mechanical adjustment. In such examples, the network node 110 and the UE 120 may refrain from communication for a duration of time indicated by the capabilities report for performing a mechanical adjustment.

In a eleventh operation 555, the UE 120 and the network node 110 may communicate. For example, the UE 120 and the network node 110 may communicate using the at least one antenna panel in accordance with performing the mechanical adjustment.

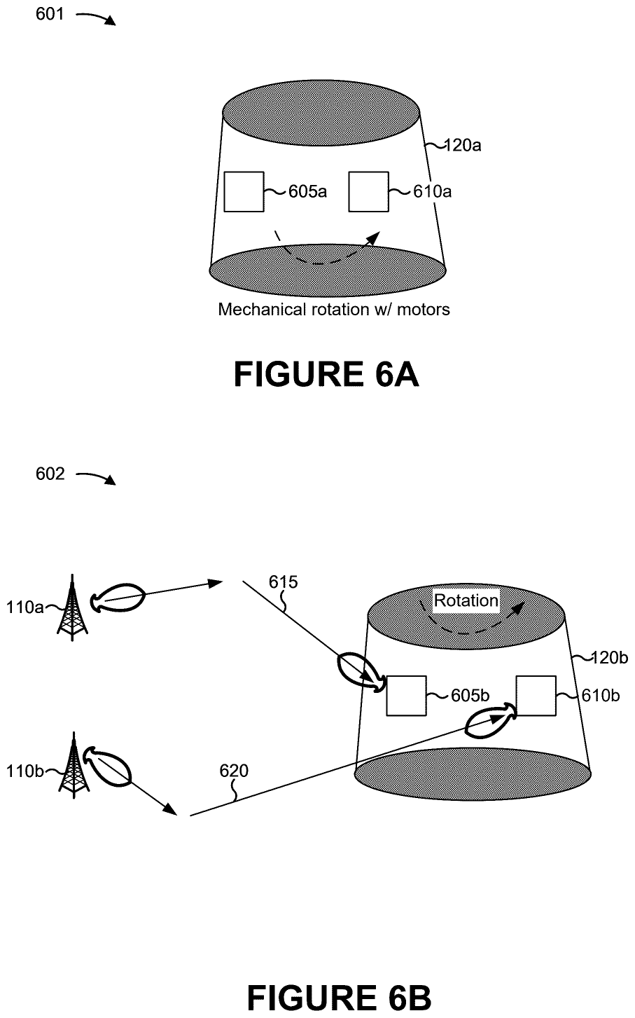

FIG. 6A is a diagram illustrating an example 601 of a mmW device with adjustable antenna panels in accordance with the present disclosure. The example 601 includes a UE 120a that may be an example of a CPE. The UE 120a may include telecommunications and/or information technology equipment that operates at a customer or user's physical location and may include a mmW device for communications in mmW frequency bands. The UE 120a may include a set of one or more antenna arrays or antenna panels including an antenna array. For example, the UE 120a in the example 601 includes at least a first antenna panel 605a and a second antenna panel 610a. The UE 120a may be an example of the UE 120a as described with reference to FIG. 4.

In the example 601, the second antenna panel 610a may be mechanically rotated and/or displaced relative to the first antenna panel 605a. In some aspects, the angular separation and/or displacement between panels may be performed to enhance different performance indicators.

The example 601 may depict a scenario for communications with multiple network nodes in which at least one mechanical displacement apparatus (for example, such as at least one motor) has rotated, reflected and/or displaced the antenna panel 610a such that the antenna panel 605a and the antenna panel 610a are non-co-located. For example, the at least one mechanical displacement may mechanically separate and/or displace the panels in the UE 120a to perform directional communications with multiple network nodes. Such angular separation between the antenna panel 605a and the antenna panel 610a may be introduced during a mechanical alignment phase (for example, the mechanical alignment phase operation may take the UE 120a a relatively long time (for example, in the order of seconds and/or minutes) to complete and transition to communicating with the multiple network nodes).

The UE 120a may coordinate the mechanical alignment phase with the one or more network nodes as described with reference to FIG. 5. For example, the UE 120a may transmit a displacement and/or rotation capability and a duration to perform the displacement and transition from refraining from communications during the mechanical alignment phase and communicating with the one or more network nodes.

In some aspects, the UE 120a may perform mechanical a mechanical adjustment of at least the second antenna panel 610a to support uplink and/or downlink performance indicators (for example, performance indicators as described in FIG. 7).

In some aspects, the UE 120a may be enabled to perform full duplex and/or sub-band full duplex operation. In such aspects, the first antenna panel 605a (or, for example, a first subset of panels of the UE 120a) may communicate via a first carrier frequency, a first frequency range, and/or a first frequency band. The second antenna panel 610a (or, for example, a second subset of panels of the UE 120a) may communicate via a second carrier frequency, a second frequency range, and/or a second frequency band. In such examples, the antenna panel 605a and the antenna panel 610a may be connected to a same network node and/or different network nodes.

In some aspects, the UE 120a may perform one or more physical adjustments to decrease cross-talk and/or leakage between communications via the first frequency band and communications via the second frequency band.

FIG. 6B is a diagram illustrating an example 600 of a mmW device with adjustable antenna panels in communication with multiple network nodes in accordance with the present disclosure. The example 602 includes a UE 120b that may be an example of a CPE, a first network node 110a, and a second network node 110b. The UE 120a may include telecommunications and/or information technology equipment that operates at a customer or user's physical location and may include a mmW device for communications in mmW frequency bands. The UE 120b may include a set of one or more antenna arrays or antenna panels including an antenna array. For example, the UE 120b in the example 602 includes at least a first antenna panel 605b and a second antenna panel 610b. The UE 120b may be an example of the UE 120a as described with reference to FIG. 4.

In the example 602, the second antenna panel 610b may be mechanically rotated and/or displaced relative to the first antenna panel 605b. In some aspects, the angular separation and/or displacement between panels may be performed to enhance different performance indicators, including downlink performance indicators. For example, the second antenna panel 610b may be mechanically adjusted to support downlink SNR associated with communications between the UE 120b and the first network node 110a via wireless communication link 615 and/or the second network node 110b via wireless communication link 620 for some communication types (for example, MIMO transmissions, such as four layer MIMO transmissions, among other examples).

FIG. 7 is a flowchart illustrating an example process 700 performed, for example, at a UE or an apparatus of a UE that supports mmW calibration in accordance with the present disclosure. Example process 700 is an example where the apparatus or the UE (for example, UE 120) performs operations associated with UE calibration of mmW devices for mechanical alignments.

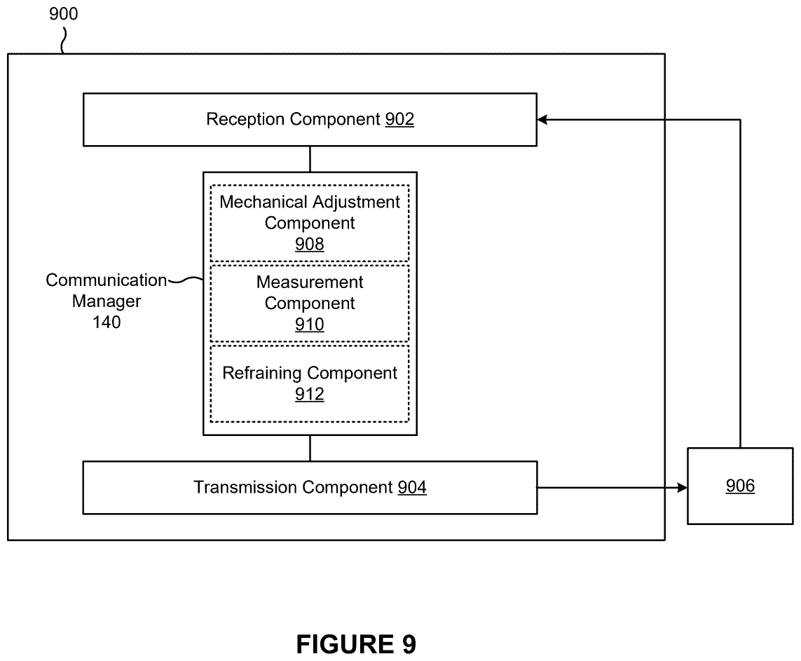

As shown in FIG. 7, in some aspects, process 700 may include communicating, in accordance with an alignment of one or more antenna panels of the UE, information for a mechanical adjustment of at least one antenna panel of a set of antenna panels of the UE relative to another antenna panel of the set of antenna panels of the UE, the information for the mechanical adjustment indicating a start time and a duration associated with performing the mechanical adjustment (block 710). For example, the UE (such as by using communication manager 140, reception component 902, or transmission component 904, depicted in FIG. 9) may communicate, in accordance with an alignment of one or more antenna panels of the UE, information for a mechanical adjustment of at least one antenna panel of a set of antenna panels of the UE relative to another antenna panel of the set of antenna panels of the UE, the information for the mechanical adjustment indicating a start time and a duration associated with performing the mechanical adjustment, as described above.

As further shown in FIG. 7, in some aspects, process 700 may include performing, in accordance with the information, the mechanical adjustment of the at least one antenna panel (block 720). For example, the UE (such as by using communication manager 140 or mechanical adjustment component 908, depicted in FIG. 9) may perform, in accordance with the information, the mechanical adjustment of the at least one antenna panel, as described above.

As further shown in FIG. 7, in some aspects, process 700 may include communicating using the at least one antenna panel in accordance with performing the mechanical adjustment (block 730). For example, the UE (such as by using communication manager 140, reception component 902, or transmission component 904, depicted in FIG. 9) may communicate using the at least one antenna panel in accordance with performing the mechanical adjustment, as described above.

Process 700 may include additional aspects, such as any single aspect or any combination of aspects described below or in connection with one or more other processes described elsewhere herein.

In a first additional aspect, process 700 includes measuring one or more performance metrics associated with communications between the UE and a network node, wherein communicating the information for the mechanical adjustment is associated with at least one of the one or more performance metrics satisfying a condition.

In a second additional aspect, alone or in combination with the first aspect, the one or more performance metrics include one or more of an alignment metric, a throughput metric, a robustness metric, an outage probability, a bit error rate, a cross talk metric, or a signal leakage metric.

In a third additional aspect, alone or in combination with one or more of the first and second aspects, communicating the information for the mechanical adjustment comprises receiving, from a network node, the information for the mechanical adjustment, wherein the mechanical adjustment includes a first mechanical displacement of the at least one antenna panel.

In a fourth additional aspect, alone or in combination with one or more of the first through third aspects, performing the mechanical adjustment comprises performing a different mechanical adjustment of the at least one antenna panel, wherein the different mechanical adjustment includes a second mechanical displacement different from the first mechanical displacement, and transmitting, to the network node, an indication of the second mechanical displacement.

In a fifth additional aspect, alone or in combination with one or more of the first through fourth aspects, receiving the information for the mechanical adjustment comprises receiving the information for the mechanical adjustment via at least one of a downlink control channel, a downlink control message, or downlink signaling.

In a sixth additional aspect, alone or in combination with one or more of the first through fifth aspects, communicating the information for the mechanical adjustment comprises transmitting, to a network node, the information for the mechanical adjustment.

In a seventh additional aspect, alone or in combination with one or more of the first through sixth aspects, transmitting the information comprises transmitting the information via at least one of an uplink control channel, an uplink control message, or uplink signaling.

In an eighth additional aspect, alone or in combination with one or more of the first through seventh aspects, process 700 includes transmitting a capability message that indicates at least one of a UE capability for performing the mechanical adjustment or a UE capability for measuring one or more performance metrics associated with communications between the UE and a network node.

In a ninth additional aspect, alone or in combination with one or more of the first through eighth aspects, the UE capability for performing the mechanical adjustment includes one or more of a mechanical adjustment capability, a rotational displacement capability, a translational displacement capability, an angular displacement capability, a duration for performing the mechanical adjustment, a duration for transitioning from performing the mechanical adjustment to communicating in accordance with performing the mechanical adjustment.

In a tenth additional aspect, alone or in combination with one or more of the first through ninth aspects, process 700 includes refraining from communicating for the duration associated with performing the mechanical adjustment.

In an eleventh additional aspect, alone or in combination with one or more of the first through tenth aspects, the information for the mechanical adjustment comprises at least one of an angular distance, a translational distance, a rotational distance, a key performance indicator, or other physical properties.

In a twelfth additional aspect, alone or in combination with one or more of the first through eleventh aspects, the mechanical adjustment includes a displacement of the at least one antenna panel with respect to an initial position of the at least one antenna panel.

In a thirteenth additional aspect, alone or in combination with one or more of the first through twelfth aspects, the mechanical adjustment includes a displacement of the at least one antenna panel with relative to the other antenna panel.

In a fourteenth additional aspect, alone or in combination with one or more of the first through thirteenth aspects, communicating the information for the mechanical adjustment associated comprises communicating information for a first mechanical adjustment of a first antenna panel of the set of antenna panels, and communicating information for a second mechanical adjustment of a second antenna panel of the set of antenna panels.

In a fifteenth additional aspect, alone or in combination with one or more of the first through fourteenth aspects, the first mechanical adjustment and the second mechanical adjustment are a same mechanical adjustment.

In a sixteenth additional aspect, alone or in combination with one or more of the first through fifteenth aspects, the first mechanical adjustment and the second mechanical adjustment are different.

In a seventeenth additional aspect, alone or in combination with one or more of the first through sixteenth aspects, communicating the information for the first mechanical adjustment of the first antenna panel of the set of antenna panels comprises receiving, from a first network node, information for the first mechanical adjustment in accordance with a first one or more performance metrics associated with communications between the UE and the first network node satisfying a first condition, and wherein communicating the information for the second mechanical adjustment associated with the second antenna panel of the UE comprises receiving, from a second network node, information for the second mechanical adjustment in accordance with a second one or more performance metrics associated with communications between the UE and the second network node satisfying at least one of the first condition or a second condition.

In an eighteenth additional aspect, alone or in combination with one or more of the first through seventeenth aspects, the at least one antenna panel is collocated with the other antenna panel of the UE prior to the mechanical adjustment.

In a nineteenth additional aspect, alone or in combination with one or more of the first through eighteenth aspects, a location of the at least one antenna panel is adjustable, and the other antenna panel has a fixed location.

In a twentieth additional aspect, alone or in combination with one or more of the first through nineteenth aspects, the information for the mechanical adjustment includes one or more of an indication of a physical property of the UE, an indication of an adjustment of the physical property of the UE, one or more key performance indicators for initiating an additional mechanical adjustment, or one or more key performance indicators that triggered the mechanical adjustment.

In a twenty-first additional aspect, alone or in combination with one or more of the first through twentieth aspects, the UE comprises a first antenna panel, of the set of antenna panels, associated with communications via a first frequency range and a second antenna panel, of the set of antenna panels, associated with communications via a second frequency range.

In a twenty-second additional aspect, alone or in combination with one or more of the first through twenty-first aspects, the information for the mechanical adjustment is associated with cross-frequency leakage of the communications via the first frequency range and the communications via the second frequency range.

Although FIG. 7 shows example blocks of process 700, in some aspects, process 700 may include additional blocks, fewer blocks, different blocks, or differently arranged blocks than those depicted in FIG. 7. Additionally or alternatively, two or more of the blocks of process 700 may be performed in parallel.

FIG. 8 is a flowchart illustrating an example process 800 performed, for example, at a network node or an apparatus of a network node that supports calibration of mmW device in accordance with the present disclosure. Example process 800 is an example where the apparatus or the network node (for example, network node 110) performs operations associated with UE calibration of mmW devices for mechanical alignments.

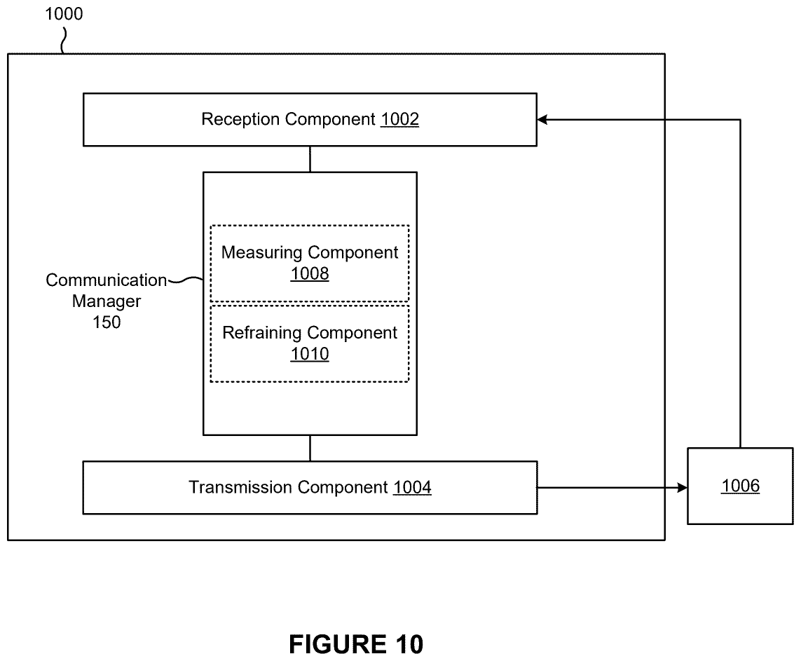

As shown in FIG. 8, in some aspects, process 800 may include communicating, in accordance with an alignment of one or more antenna panels of a UE, information for a mechanical adjustment of at least one antenna panel of a set of antenna panels of the UE relative to another antenna panel of the set of antenna panels of the UE, the information for the mechanical adjustment indicating a start time and a duration associated with performance of the mechanical adjustment (block 810). For example, the network node (such as by using communication manager 150, reception component 1002, or transmission component 1004, depicted in FIG. 10) may communicate, in accordance with an alignment of one or more antenna panels of a UE, information for a mechanical adjustment of at least one antenna panel of a set of antenna panels of the UE relative to another antenna panel of the set of antenna panels of the UE, the information for the mechanical adjustment indicating a start time and a duration associated with performance of the mechanical adjustment, as described above.

As further shown in FIG. 8, in some aspects, process 800 may include communicating using the at least one antenna panel in accordance with the communicating the information for the mechanical adjustment (block 820). For example, the network node (such as by using communication manager 150, reception component 1002, or transmission component 1004, depicted in FIG. 10) may communicate using the at least one antenna panel in accordance with the communicating the information for the mechanical adjustment, as described above.

Process 800 may include additional aspects, such as any single aspect or any combination of aspects described below or in connection with one or more other processes described elsewhere herein.

In a first additional aspect, process 800 includes obtaining a measurement of one or more performance metrics associated with communications between the UE and the network node, wherein communicating the information for the mechanical adjustment is associated with at least one of the one or more performance metrics satisfying a condition.

In a second additional aspect, alone or in combination with the first aspect, the one or more performance metrics include one or more of an alignment metric, a throughput metric, a robustness metric, an outage probability, a bit error rate, a cross talk metric, or a signal leakage metric.

In a third additional aspect, alone or in combination with one or more of the first and second aspects, communicating the information for the mechanical adjustment comprises transmitting the information for the mechanical adjustment, wherein the mechanical adjustment includes a first mechanical displacement of the at least one antenna panel.

In a fourth additional aspect, alone or in combination with one or more of the first through third aspects, process 800 includes receiving an indication of a different mechanical adjustment, of the at least one antenna panel, performed by the UE.

In a fifth additional aspect, alone or in combination with one or more of the first through fourth aspects, transmitting the information for the mechanical adjustment comprises transmitting the information for the mechanical adjustment via at least one of a downlink control channel, a downlink control message, or downlink signaling.

In a sixth additional aspect, alone or in combination with one or more of the first through fifth aspects, communicating the information for the mechanical adjustment comprises receiving, from the UE, the information for the mechanical adjustment.

In a seventh additional aspect, alone or in combination with one or more of the first through sixth aspects, receiving the information comprises receiving the information via at least one of an uplink control channel, an uplink control message, or uplink signaling.

In an eighth additional aspect, alone or in combination with one or more of the first through seventh aspects, process 800 includes receiving a capability message that indicates at least one of a UE capability for performing the mechanical adjustment or a UE capability for measuring one or more performance metrics associated with communications between the UE and the network node.

In a ninth additional aspect, alone or in combination with one or more of the first through eighth aspects, the UE capability for performing the mechanical adjustment includes one or more of a mechanical adjustment capability, a rotational displacement capability, a translational displacement capability, an angular displacement capability, a duration for performing the mechanical adjustment, a duration for transitioning from performing the mechanical adjustment to communicating in accordance with performing the mechanical adjustment.

In a tenth additional aspect, alone or in combination with one or more of the first through ninth aspects, process 800 includes refraining from communicating with the UE for the duration associated with the performance of the mechanical adjustment.

In an eleventh additional aspect, alone or in combination with one or more of the first through tenth aspects, the information for the mechanical adjustment comprises at least one of an angular distance, a translation distance, a rotational distance, a key performance indicator, or other physical properties.

In a twelfth additional aspect, alone or in combination with one or more of the first through eleventh aspects, communicating the information for the mechanical adjustment associated comprises communicating information for a first mechanical adjustment associated with a first antenna panel of the set of antenna panels, and communicating information for a second mechanical adjustment associated with a second antenna panel of the set of antenna panels.

In a thirteenth additional aspect, alone or in combination with one or more of the first through twelfth aspects, the first mechanical adjustment and the second mechanical adjustment are a same mechanical adjustment.

In a fourteenth additional aspect, alone or in combination with one or more of the first through thirteenth aspects, the first mechanical adjustment and the second mechanical adjustment are different.

In a fifteenth additional aspect, alone or in combination with one or more of the first through fourteenth aspects, the information for the mechanical adjustment includes one or more of an indication of a physical property of the UE, an indication of an adjustment of the physical property of the UE, one or more key performance indicators for initiating an additional mechanical adjustment, or one or more key performance indicators that triggered the mechanical adjustment.

Although FIG. 8 shows example blocks of process 800, in some aspects, process 800 may include additional blocks, fewer blocks, different blocks, or differently arranged blocks than those depicted in FIG. 8. Additionally or alternatively, two or more of the blocks of process 800 may be performed in parallel.

FIG. 9 is a diagram of an example apparatus 900 for wireless communication that supports calibration of mmW devices in accordance with the present disclosure. The apparatus 900 may be a UE, or a UE may include the apparatus 900. In some aspects, the apparatus 900 includes a reception component 902, a transmission component 904, and a communication manager 140, which may be in communication with one another (for example, via one or more buses). As shown, the apparatus 900 may communicate with another apparatus 906 (such as a UE, a network node, or another wireless communication device) using the reception component 902 and the transmission component 904.

In some aspects, the apparatus 900 may be configured to and/or operable to perform one or more operations described herein in connection with FIGS. 5-6. Additionally or alternatively, the apparatus 900 may be configured to and/or operable to perform one or more processes described herein, such as process 700 of FIG. 7. In some aspects, the apparatus 900 may include one or more components of the UE described above in connection with FIG. 1 and FIG. 2.

The reception component 902 may receive communications, such as reference signals, control information, and/or data communications, from the apparatus 906. The reception component 902 may provide received communications to one or more other components of the apparatus 900, such as the communication manager 140. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 902 may include one or more antennas, one or more modems, one or more demodulators, one or more MIMO detectors, one or more receive processors, one or more controllers/processors, and/or one or more memories of the UE described above in connection with FIG. 1 and FIG. 2.

The transmission component 904 may transmit communications, such as reference signals, control information, and/or data communications, to the apparatus 906. In some aspects, the communication manager 140 may generate communications and may transmit the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, one or more modems, one or more modulators, one or more transmit MIMO processors, one or more transmit processors, one or more controllers/processors, and/or one or more memories of the UE described above in connection with FIG. 1 and FIG. 2. In some aspects, the transmission component 904 may be co-located with the reception component 902 in one or more transceivers.

The communication manager 140 may communicate, in accordance with an alignment of one or more antenna panels of the UE, information for a mechanical adjustment of at least one antenna panel of a set of antenna panels of the UE relative to another antenna panel of the set of antenna panels of the UE, the information for the mechanical adjustment indicating a start time and a duration associated with performing the mechanical adjustment. The communication manager 140 may perform, in accordance with the information, the mechanical adjustment of the at least one antenna panel. The communication manager 140 may communicate using the at least one antenna panel in accordance with performing the mechanical adjustment. In some aspects, the communication manager 140 may perform one or more operations described elsewhere herein as being performed by one or more components of the communication manager 140.

The communication manager 140 may include one or more controllers/processors, and/or one or more memories of the UE described above in connection with FIG. 1 and FIG. 2. In some aspects, the communication manager 140 includes a set of components, such as a mechanical adjustment component 908, a measurement component 910 and/or a refraining component 912. Alternatively, the set of components may be separate and distinct from the communication manager 140. In some aspects, one or more components of the set of components may include or may be implemented within one or more controllers/processors, and/or one or more memories of the UE described above in connection with FIG. 1 and FIG. 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 and/or the transmission component 904 may communicate, in accordance with an alignment of one or more antenna panels of the UE, information for a mechanical adjustment of at least one antenna panel of a set of antenna panels of the UE relative to another antenna panel of the set of antenna panels of the UE, the information for the mechanical adjustment indicating a start time and a duration associated with performing the mechanical adjustment. The mechanical adjustment component 908 may perform, in accordance with the information, the mechanical adjustment of the at least one antenna panel. The reception component 902 and/or the transmission component 904 may communicate using the at least one antenna panel in accordance with performing the mechanical adjustment.

The measurement component 910 may measure one or more performance metrics associated with communications between the UE and a network node, wherein communicating the information for the mechanical adjustment is associated with at least one of the one or more performance metrics satisfying a condition.

The transmission component 904 may transmit a capability message that indicates at least one of a UE capability for performing the mechanical adjustment or a UE capability for measuring one or more performance metrics associated with communications between the UE and a network node.

The refraining component 912 may refrain from communicating for the duration associated with performing the mechanical adjustment.

The quantity and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally or alternatively, a set of (one or more) components shown in FIG. 9 may perform one or more functions described as being performed by another set of components shown in FIG. 9.

FIG. 10 is a diagram of an example apparatus 1000 for wireless communication that supports calibration of mmW devices in accordance with the present disclosure. The apparatus 1000 may be a network node, or a network node may include the apparatus 1000. In some aspects, the apparatus 1000 includes a reception component 1002, a transmission component 1004, and a communication manager 150, which may be in communication with one another (for example, via one or more buses). As shown, the apparatus 1000 may communicate with another apparatus 1006 (such as a UE, a network node, or another wireless communication device) using the reception component 1002 and the transmission component 1004.

In some aspects, the apparatus 1000 may be configured to and/or operable to perform one or more operations described herein in connection with FIGS. 5-6. Additionally or alternatively, the apparatus 1000 may be configured to and/or operable to perform one or more processes described herein, such as process 800 of FIG. 8. In some aspects, the apparatus 1000 may include one or more components of the network node described above in connection with FIG. 1 and FIG. 2.

The reception component 1002 may receive communications, such as reference signals, control information, and/or data communications, from the apparatus 1006. The reception component 1002 may provide received communications to one or more other components of the apparatus 1000, such as the communication manager 150. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1002 may include one or more antennas, one or more modems, one or more demodulators, one or more MIMO detectors, one or more receive processors, one or more controllers/processors, and/or one or more memories of the network node described above in connection with FIG. 1 and FIG. 2.

The transmission component 1004 may transmit communications, such as reference signals, control information, and/or data communications, to the apparatus 1006. In some aspects, the communication manager 150 may generate communications and may transmit the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, one or more modems, one or more modulators, one or more transmit MIMO processors, one or more transmit processors, one or more controllers/processors, and/or one or more memories of the network node described above in connection with FIG. 1 and FIG. 2. In some aspects, the transmission component 1004 may be co-located with the reception component 1002 in one or more transceivers.

The communication manager 150 may communicate, in accordance with an alignment of one or more antenna panels of a UE, information for a mechanical adjustment of at least one antenna panel of a set of antenna panels of the UE relative to another antenna panel of the set of antenna panels of the UE, the information for the mechanical adjustment indicating a start time and a duration associated with performance of the mechanical adjustment. The communication manager 150 may communicate using the at least one antenna panel in accordance with the communicating the information for the mechanical adjustment. In some aspects, the communication manager 150 may perform one or more operations described elsewhere herein as being performed by one or more components of the communication manager 150.

The communication manager 150 may include one or more controllers/processors, one or more memories, one or more schedulers, and/or one or more communication units of the network node described above in connection with FIG. 1 and FIG. 2. In some aspects, the communication manager 150 includes a set of components, such as a measurement component 1008, and/or a refraining component 1010. Alternatively, the set of components may be separate and distinct from the communication manager 150. In some aspects, one or more components of the set of components may include or may be implemented within one or more controllers/processors, one or more memories, one or more schedulers, and/or one or more communication units of the network node described above in connection with FIG. 1 and FIG. 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 and/or the transmission component 1004 may communicate, in accordance with an alignment of one or more antenna panels of a UE, information for a mechanical adjustment of at least one antenna panel of a set of antenna panels of the UE relative to another antenna panel of the set of antenna panels of the UE, the information for the mechanical adjustment indicating a start time and a duration associated with performance of the mechanical adjustment. The reception component 1002 and/or the transmission component 1004 may communicate using the at least one antenna panel in accordance with the communicating the information for the mechanical adjustment.

The measurement component 1008 may obtain a measurement of one or more performance metrics associated with communications between the UE and the network node, wherein communicating the information for the mechanical adjustment is associated with at least one of the one or more performance metrics satisfying a condition.

The reception component 1002 may receive an indication of a different mechanical adjustment, of the at least one antenna panel, performed by the UE.

The reception component 1002 may receive a capability message that indicates at least one of a UE capability for performing the mechanical adjustment or a UE capability for measuring one or more performance metrics associated with communications between the UE and the network node.

The refraining component 1010 may refrain from communicating with the UE for the duration associated with the performance of the mechanical adjustment.

The quantity and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication by a user equipment (UE), comprising: communicating, in accordance with an alignment of one or more antenna panels of the UE, information for a mechanical adjustment of at least one antenna panel of a set of antenna panels of the UE relative to another antenna panel of the set of antenna panels of the UE, the information for the mechanical adjustment indicating a start time and a duration associated with performing the mechanical adjustment; performing, in accordance with the information, the mechanical adjustment of the at least one antenna panel; and communicating using the at least one antenna panel in accordance with performing the mechanical adjustment.

Aspect 2: The method of Aspect 1, the method further comprising: measuring one or more performance metrics associated with communications between the UE and a network node, wherein communicating the information for the mechanical adjustment is associated with at least one of the one or more performance metrics satisfying a condition.

Aspect 3: The method of Aspect 2, wherein the one or more performance metrics include one or more of: an alignment metric, a throughput metric, a robustness metric, an outage probability, a bit error rate, a cross talk metric, or a signal leakage metric.

Aspect 4: The method of any of Aspects 1-3, wherein communicating the information for the mechanical adjustment comprises: receiving, from a network node, the information for the mechanical adjustment, wherein the mechanical adjustment includes a first mechanical displacement of the at least one antenna panel.

Aspect 5: The method of Aspect 4, wherein performing the mechanical adjustment comprises: performing a different mechanical adjustment of the at least one antenna panel, wherein the different mechanical adjustment includes a second mechanical displacement different from the first mechanical displacement; and transmitting, to the network node, an indication of the second mechanical displacement.

Aspect 6: The method of any of Aspects 4-5, wherein receiving the information for the mechanical adjustment comprises: receiving the information for the mechanical adjustment via at least one of a downlink control channel, a downlink control message, or downlink signaling.

Aspect 7: The method of any of Aspects 1-6, wherein communicating the information for the mechanical adjustment comprises: transmitting, to a network node, the information for the mechanical adjustment.

Aspect 8: The method of Aspect 7, wherein transmitting the information comprises: transmitting the information via at least one of an uplink control channel, an uplink control message, or uplink signaling.

Aspect 9: The method of any of Aspects 1-8, further comprising: transmitting a capability message that indicates at least one of a UE capability for performing the mechanical adjustment or a UE capability for measuring one or more performance metrics associated with communications between the UE and a network node.

Aspect 10: The method of Aspect 9, wherein the UE capability for performing the mechanical adjustment includes one or more of: a mechanical adjustment capability, a rotational displacement capability, a translational displacement capability, an angular displacement capability, a duration for performing the mechanical adjustment, a duration for transitioning from performing the mechanical adjustment to communicating in accordance with performing the mechanical adjustment.

Aspect 11: The method of any of Aspects 1-10, further comprising: refraining from communicating for the duration associated with performing the mechanical adjustment.

Aspect 12: The method of any of Aspects 1-11, wherein the information for the mechanical adjustment comprises at least one of: an angular distance, a translational distance, a rotational distance, a key performance indicator, or other physical properties.

Aspect 13: The method of any of Aspects 1-12, wherein the mechanical adjustment includes a displacement of the at least one antenna panel with respect to an initial position of the at least one antenna panel.

Aspect 14: The method of any of Aspects 1-13, wherein the mechanical adjustment includes a displacement of the at least one antenna panel with relative to the other antenna panel.

Aspect 15: The method of any of Aspects 1-14, wherein communicating the information for the mechanical adjustment associated comprises: communicating information for a first mechanical adjustment of a first antenna panel of the set of antenna panels; and communicating information for a second mechanical adjustment of a second antenna panel of the set of antenna panels.

Aspect 16: The method of Aspect 15, wherein the first mechanical adjustment and the second mechanical adjustment are a same mechanical adjustment.

Aspect 17: The method of Aspect 15, wherein the first mechanical adjustment and the second mechanical adjustment are different.

Aspect 18: The method of any of Aspects 15-17, wherein communicating the information for the first mechanical adjustment of the first antenna panel of the set of antenna panels comprises: receiving, from a first network node, information for the first mechanical adjustment in accordance with a first one or more performance metrics associated with communications between the UE and the first network node satisfying a first condition; and wherein communicating the information for the second mechanical adjustment associated with the second antenna panel of the UE comprises: receiving, from a second network node, information for the second mechanical adjustment in accordance with a second one or more performance metrics associated with communications between the UE and the second network node satisfying at least one of the first condition or a second condition.

Aspect 19: The method of any of Aspects 1-18, wherein the at least one antenna panel is collocated with the other antenna panel of the UE prior to the mechanical adjustment.

Aspect 20: The method of any of Aspects 1-19, wherein a location of the at least one antenna panel is adjustable, and the other antenna panel has a fixed location.

Aspect 21: The method of any of Aspects 1-20, wherein the information for the mechanical adjustment includes one or more of: an indication of a physical property of the UE, an indication of an adjustment of the physical property of the UE, one or more key performance indicators for initiating an additional mechanical adjustment, or one or more key performance indicators that triggered the mechanical adjustment.

Aspect 22: The method of any of Aspects 1-21, wherein the UE comprises a first antenna panel, of the set of antenna panels, associated with communications via a first frequency range and a second antenna panel, of the set of antenna panels, associated with communications via a second frequency range.

Aspect 23: The method of Aspect 22, wherein the information for the mechanical adjustment is associated with cross-frequency leakage of the communications via the first frequency range and the communications via the second frequency range.

Aspect 24: A method of wireless communication by a network node, comprising: communicating, in accordance with an alignment of one or more antenna panels of a user equipment (UE), information for a mechanical adjustment of at least one antenna panel of a set of antenna panels of the UE relative to another antenna panel of the set of antenna panels of the UE, the information for the mechanical adjustment indicating a start time and a duration associated with performance of the mechanical adjustment; and communicating using the at least one antenna panel in accordance with the communicating the information for the mechanical adjustment.

Aspect 25: The method of Aspect 24, the method further comprising: obtaining a measurement of one or more performance metrics associated with communications between the UE and the network node, wherein communicating the information for the mechanical adjustment is associated with at least one of the one or more performance metrics satisfying a condition.

Aspect 26: The method of Aspect 25, wherein the one or more performance metrics include one or more of: an alignment metric, a throughput metric, a robustness metric, an outage probability, a bit error rate, a cross talk metric, or a signal leakage metric.

Aspect 27: The method of any of Aspects 24-26, wherein communicating the information for the mechanical adjustment comprises: transmitting the information for the mechanical adjustment, wherein the mechanical adjustment includes a first mechanical displacement of the at least one antenna panel.

Aspect 28: The method of Aspect 27, further comprising: receiving an indication of a different mechanical adjustment, of the at least one antenna panel, performed by the UE.

Aspect 29: The method of any of Aspects 27-28, wherein transmitting the information for the mechanical adjustment comprises: transmitting the information for the mechanical adjustment via at least one of a downlink control channel, a downlink control message, or downlink signaling.

Aspect 30: The method of any of Aspects 24-29, wherein communicating the information for the mechanical adjustment comprises: receiving, from the UE, the information for the mechanical adjustment.

Aspect 31: The method of Aspect 30, wherein receiving the information comprises: receiving the information via at least one of an uplink control channel, an uplink control message, or uplink signaling.

Aspect 32: The method of any of Aspects 24-31, further comprising: receiving a capability message that indicates at least one of a UE capability for performing the mechanical adjustment or a UE capability for measuring one or more performance metrics associated with communications between the UE and the network node.

Aspect 33: The method of Aspect 32, wherein the UE capability for performing the mechanical adjustment includes one or more of: a mechanical adjustment capability, a rotational displacement capability, a translational displacement capability, an angular displacement capability, a duration for performing the mechanical adjustment, a duration for transitioning from performing the mechanical adjustment to communicating in accordance with performing the mechanical adjustment.

Aspect 34: The method of any of Aspects 24-33, further comprising: refraining from communicating with the UE for the duration associated with the performance of the mechanical adjustment.

Aspect 35: The method of any of Aspects 24-34, wherein the information for the mechanical adjustment comprises at least one of: an angular distance, a translation distance, a rotational distance, a key performance indicator, or other physical properties.

Aspect 36: The method of any of Aspects 24-35, wherein communicating the information for the mechanical adjustment associated comprises: communicating information for a first mechanical adjustment associated with a first antenna panel of the set of antenna panels; and communicating information for a second mechanical adjustment associated with a second antenna panel of the set of antenna panels.

Aspect 37: The method of Aspect 36, wherein the first mechanical adjustment and the second mechanical adjustment are a same mechanical adjustment.

Aspect 38: The method of Aspect 36, wherein the first mechanical adjustment and the second mechanical adjustment are different.

Aspect 39: The method of any of Aspects 24-38, wherein the information for the mechanical adjustment includes one or more of: an indication of a physical property of the UE, an indication of an adjustment of the physical property of the UE, one or more key performance indicators for initiating an additional mechanical adjustment, or one or more key performance indicators that triggered the mechanical adjustment.

Aspect 40: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-39.

Aspect 41: An apparatus for wireless communication at a device, the apparatus comprising one or more memories and one or more processors coupled to the one or more memories, the one or more processors configured to cause the device to perform the method of one or more of Aspects 1-39.

Aspect 42: An apparatus for wireless communication, the apparatus comprising at least one means for performing the method of one or more of Aspects 1-39.

Aspect 43: A non-transitory computer-readable medium storing code for wireless communication, the code comprising instructions executable by one or more processors to perform the method of one or more of Aspects 1-39.

Aspect 44: A non-transitory computer-readable medium storing a set of instructions for wireless communication, the set of instructions comprising one or more instructions that, when executed by one or more processors of a device, cause the device to perform the method of one or more of Aspects 1-39.

Aspect 45: A device for wireless communication, the device comprising a processing system that includes one or more processors and one or more memories coupled with the one or more processors, the processing system configured to cause the device to perform the method of one or more of Aspects 1-39.

Aspect 46: An apparatus for wireless communication at a device, the apparatus comprising one or more memories and one or more processors coupled to the one or more memories, the one or more processors individually or collectively configured to cause the device to perform the method of one or more of Aspects 1-39.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
a processing system that includes one or more processors and one or more memories coupled with the one or more processors, the processing system configured to cause the UE to:
communicate, in accordance with an alignment of one or more antenna panels of the UE, information for a mechanical adjustment of at least one antenna panel of a set of antenna panels of the UE relative to another antenna panel of the set of antenna panels of the UE, the information for the mechanical adjustment indicating a start time and a duration associated with performing the mechanical adjustment;
perform, in accordance with the information, the mechanical adjustment of the at least one antenna panel; and
communicate using the at least one antenna panel in accordance with performing the mechanical adjustment.

2. The UE of claim 1, wherein the processing system is further configured to cause the UE to:
measure one or more performance metrics associated with communications between the UE and a network node, wherein communicating the information for the mechanical adjustment is associated with at least one of the one or more performance metrics satisfying a condition.

3. The UE of claim 2, wherein the one or more performance metrics include one or more of:
an alignment metric,
a throughput metric,
a robustness metric,
an outage probability,
a bit error rate,
a cross talk metric, or
a signal leakage metric.

4. The UE of claim 1, wherein, to cause the UE to communicate the information for the mechanical adjustment, the processing system is configured to cause the UE to:
receive, from a network node, the information for the mechanical adjustment, wherein the mechanical adjustment includes a first mechanical displacement of the at least one antenna panel.

5. The UE of claim 4, wherein, to cause the UE to perform the mechanical adjustment, the processing system is configured to cause the UE to:
perform a different mechanical adjustment of the at least one antenna panel, wherein the different mechanical adjustment includes a second mechanical displacement different from the first mechanical displacement; and
transmit, to the network node, an indication of the second mechanical displacement.

6. The UE of claim 4, wherein, to cause the UE to receive the information for the mechanical adjustment, the processing system is configured to cause the UE to:
receive the information for the mechanical adjustment via at least one of a downlink control channel, a downlink control message, or downlink signaling.

7. The UE of claim 1, wherein, to cause the UE to communicate the information for the mechanical adjustment, the processing system is configured to cause the UE to:
transmit, to a network node, the information for the mechanical adjustment.

8. The UE of claim 7, wherein, to cause the UE to transmit the information, the processing system is configured to cause the UE to:
transmit the information via at least one of an uplink control channel, an uplink control message, or uplink signaling.

9. A method of wireless communication performed by a user equipment (UE), comprising:
communicating, in accordance with an alignment of one or more antenna panels of the UE, information for a mechanical adjustment of at least one antenna panel of a set of antenna panels of the UE relative to another antenna panel of the set of antenna panels of the UE, the information for the mechanical adjustment indicating a start time and a duration associated with performing the mechanical adjustment;
performing, in accordance with the information, the mechanical adjustment of the at least one antenna panel; and
communicating using the at least one antenna panel in accordance with performing the mechanical adjustment.

10. The method of claim 9, further comprising:
transmitting a capability message that indicates at least one of a UE capability for performing the mechanical adjustment or a UE capability for measuring one or more performance metrics associated with communications between the UE and a network node.

11. The method of claim 10, wherein the UE capability for performing the mechanical adjustment includes one or more of:
a mechanical adjustment capability,
a rotational displacement capability,
a translational displacement capability,
an angular displacement capability,
a duration for performing the mechanical adjustment,
a duration for transitioning from performing the mechanical adjustment to communicating in accordance with performing the mechanical adjustment.

12. The method of claim 9, further comprising:
refraining from communicating for the duration associated with performing the mechanical adjustment.

13. The method of claim 9, wherein the information for the mechanical adjustment comprises at least one of:
an angular distance,
a translational distance,
a rotational distance,
a key performance indicator, or
other physical properties.

14. The method of claim 9, wherein the mechanical adjustment includes:
a displacement of the at least one antenna panel with respect to an initial position of the at least one antenna panel, or
a displacement of the at least one antenna panel with relative to the other antenna panel.

15. The method of claim 9, wherein communicating the information for the mechanical adjustment associated comprises:
communicating information for a first mechanical adjustment of a first antenna panel of the set of antenna panels; and
communicating information for a second mechanical adjustment of a second antenna panel of the set of antenna panels.

16. The method of claim 15, wherein communicating the information for the first mechanical adjustment of the first antenna panel of the set of antenna panels comprises:
receiving, from a first network node, information for the first mechanical adjustment in accordance with a first one or more performance metrics associated with communications between the UE and the first network node satisfying a first condition;
and wherein communicating the information for the second mechanical adjustment associated with the second antenna panel of the UE comprises:
receiving, from a second network node, information for the second mechanical adjustment in accordance with a second one or more performance metrics associated with communications between the UE and the second network node satisfying at least one of the first condition or a second condition.

17. An apparatus for wireless communication, comprising:
means for communicating, in accordance with an alignment of one or more antenna panels of the UE, information for a mechanical adjustment of at least one antenna panel of a set of antenna panels of the UE relative to another antenna panel of the set of antenna panels of the UE, the information for the mechanical adjustment indicating a start time and a duration associated with performing the mechanical adjustment;
means for performing, in accordance with the information, the mechanical adjustment of the at least one antenna panel; and
means for communicating using the at least one antenna panel in accordance with performing the mechanical adjustment.

18. The apparatus of claim 17, wherein the information for the mechanical adjustment includes one or more of:
an indication of a physical property of the UE,
an indication of an adjustment of the physical property of the UE,
one or more key performance indicators for initiating an additional mechanical adjustment, or
one or more key performance indicators that triggered the mechanical adjustment.

19. The apparatus of claim 17, wherein the UE comprises a first antenna panel, of the set of antenna panels, associated with communications via a first frequency range and a second antenna panel, of the set of antenna panels, associated with communications via a second frequency range.

20. The apparatus of claim 19, wherein the information for the mechanical adjustment is associated with cross-frequency leakage of the communications via the first frequency range and the communications via the second frequency range.
one or more key performance indicators for initiating an additional mechanical adjustment, or
one or more key performance indicators that triggered the mechanical adjustment.
